(19) United States
(12) Patent Application Publication
(10) Pub. No.: US 2014/0305414 A1
(43) Pub. Date: Oct. 16, 2014

(54) HEAT EXCHANGER HOUSING

(71) Applicant: ELECTRO-MOTIVE DIESEL, INC., LaGrange, IL (US)

(72) Inventors: Joshua Schueler, New Lenox, IL (US); Gary R. Svihla, Burr Ridge, IL (US)

(73) Assignee: Electro-Motive Diesel, Inc., LaGrange, IL (US)

(21) Appl. No.: 13/861,557

(22) Filed: Apr. 12, 2013

(51) Int. Cl. F02B 29/04; F28F 9/22

(52) U.S. Cl. CPC F02B 29/0462; F28F 9/22
USPC 123/563; 165/159

(57) ABSTRACT

Housing for cooling air prior to introduction to an engine is provided. The housing includes a cooling chamber and an inlet chamber fluidically connected to the cooling chamber. The cooling chamber includes four side walls, a top wall and a bottom wall. The inlet chamber includes a top surface laterally extending from the top wall of the cooling chamber and an inlet disposed on the top surface. The inlet is configured to direct the air in a first direction. Further, the inlet chamber includes a bottom surface laterally extending from a side wall of the cooling chamber and disposed substantially perpendicular to the first direction at a predetermined distance from the top surface of the inlet chamber. The bottom surface is configured to turn the fluid in a second direction substantially perpendicular to the first direction prior to entering into the cooling chamber.

### TECHNICAL FIELD

The present disclosure relates to an engine system, and more particularly to a heat exchanger for the engine.

### BACKGROUND

Use of turbocharged engines is generally known. As a turbocharger increases the quantity of the air taken for combustion in the engine, it also increases the temperature of the intake air. Therefore, for cooling the intake air, a heat exchanger may be used between the turbocharger and intake manifolds of the engine. The heat exchanger includes coolant that flows through a heat exchanger core of the heat exchanger and further cools down the high temperature air from the turbocharger. However, maintaining a high pressure with low temperature is an essential feature of the heat exchanger.

U.S. Pat. No. 6,311,676 relates to an arrangement for cooling the temperature of a source of air prior to introduction into a motor vehicle engine includes an intercooler core and an intercooler housing. The intercooler core has a generally cylindrical shape. The intercooler housing defines an inner chamber receiving the intercooler core. The intercooler housing has an intake side with at least one intake port in communication with the intercooler core and an outlet side with at least one outlet port in communication with the intercooler core. The intake side and the outlet side are spaced apart and parallel.

### SUMMARY OF THE DISCLOSURE

In one aspect of the present disclosure, a housing for cooling air prior to introduction to an engine is provided. The housing includes a cooling chamber and an inlet chamber fluidically connected to the cooling chamber. The cooling chamber includes four side walls, a top wall and a bottom wall. The inlet chamber includes a top surface laterally extending from the top wall of the cooling chamber. Further, the inlet chamber includes an inlet disposed on the top surface of the inlet chamber and configured to direct the air in a first direction. Furthermore, the inlet chamber includes a bottom surface laterally extending from a side wall of the cooling chamber and disposed substantially perpendicular to the first direction at a predetermined distance from the top surface of the inlet chamber. The bottom surface is configured to turn the fluid in a second direction substantially perpendicular to the first direction prior to entering into the cooling chamber.

In another aspect of the present disclosure, a heat exchanger housing is provided. The heat exchanger housing includes a cooling chamber and an inlet chamber fluidically connected to the cooling chamber. The cooling chamber includes four side walls, a top wall and a bottom wall. The inlet chamber includes a top surface laterally extending from the top wall of the cooling chamber. Further, the inlet chamber includes an inlet disposed on the top surface of the inlet chamber and configured to direct the air in a first direction. Furthermore, the inlet chamber includes a bottom surface laterally extending from a side wall of the cooling chamber and disposed substantially perpendicular to the first direction at a predetermined distance from the top surface of the inlet chamber. The bottom surface is configured to turn the fluid in a second direction substantially perpendicular to the first direction prior to entering into the cooling chamber.

In a yet another aspect of the present disclosure, a heat exchanger is provided. The heat exchanger includes a heat exchanger core and heat exchanger housing. The heat exchanger housing includes a cooling chamber and an inlet chamber fluidically connected to the cooling chamber. The cooling chamber includes four side walls, a top wall and a bottom wall. The inlet chamber includes a top surface laterally extending from the top wall of the cooling chamber. Further, the inlet chamber includes an inlet disposed on the top surface of the inlet chamber and configured to direct the air in a first direction. Furthermore, the inlet chamber includes a bottom surface laterally extending from a side wall of the cooling chamber and disposed substantially perpendicular to the first direction at a predetermined distance from the top surface of the inlet chamber. The bottom surface is configured to turn the fluid in a second direction substantially perpendicular to the first direction prior to entering into the cooling chamber.

Other features and aspects of this disclosure will be apparent from the following description and the accompanying drawings.

### BRIEF DESCRIPTION OF THE DRAWINGS

FIG. 1 illustrates a schematic view of an exemplary engine system;

FIG. 2 illustrates an exemplary heat exchanger of the air supply unit according to an embodiment of this disclosure; and

FIG. 3 illustrates a sectional view of the heat exchanger of FIG. 2.

### DETAILED DESCRIPTION

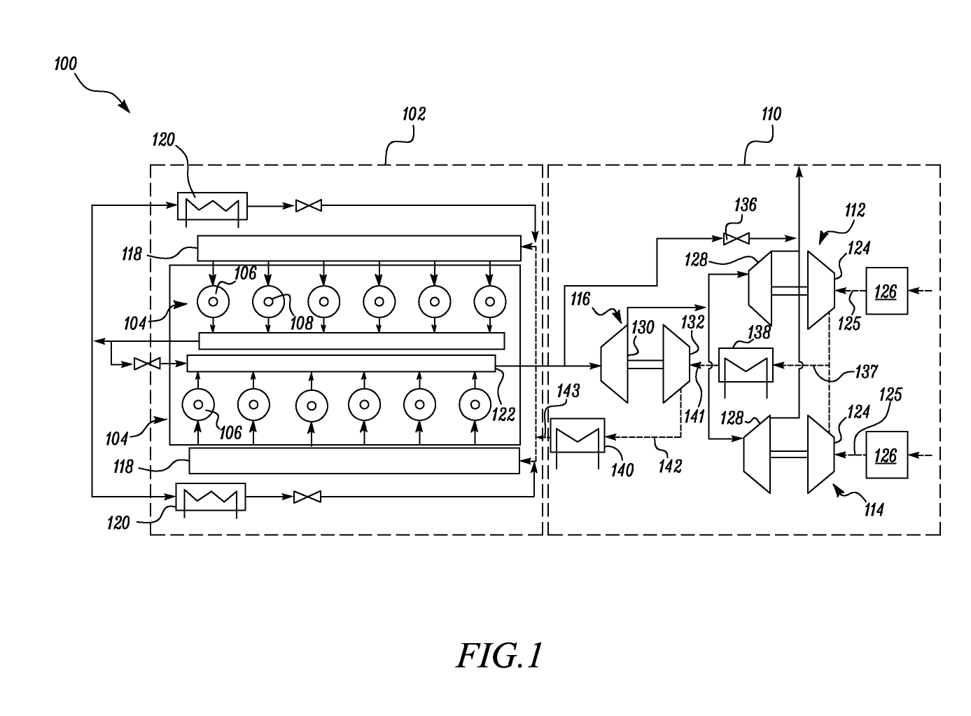

The present disclosure relates to a heat exchanger in an engine system. The present disclosure will now be described in detail with reference being made to accompanying figures. FIG. 1 illustrates a schematic representation of an engine system 100. Various embodiments described herein have been explained for a diesel engine. However, it may be contemplated that the described embodiments may be implemented with any type of spark-ignited engine such as a gasoline engine, a natural gas engine, or an engine using gaseous fuels like propane, or methane. The engine system 100 includes an engine 102 having one or more cylinders 104 made of metallic alloys such as steel, aluminum based alloys, etc. The cylinders 104 may include pistons (not shown), adapted to reciprocate therein and define a combustion chamber 106. Further, the engine 102 may further include fuel injectors 108 to supply fuel into the combustion chamber 106.

The engine system 100 may further include an air supply unit 110 to supply air into the combustion chamber 106. According to an exemplary embodiment of the present disclosure, the air supply unit 110 may include one or more first stage turbochargers 112, 114, such as low pressure turbochargers, and a second stage turbocharger 116, such as a high pressure turbocharger, to provide compressed air into an air inlet manifold 118 to be finally drawn into the combustion chamber 106. During operation of the engine system 100, the fuel mixes with the air for combustion in the combustion chamber 106 and a portion of the exhaust gases is cooled by one or more exhaust gas recirculation (EGR) cooler 120 and recirculated via an exhaust manifold 122.

Ambient air is drawn into a compressor section 124 (as shown by arrows 125) of the first stage turbochargers 112, 114 via one or more air filters 126. Each of the first stage turbochargers 112, 114 also includes a turbine section 128 which is drivably connected to the compressor section 124 and configured to drive the compressor section 124 to compress the ambient air. Similarly, the second stage turbocharger 116 includes a turbine section 130 and a compressor section 132. The turbine section 130 of the second stage turbocharger 116 is configured to receive exhaust gases from the exhaust manifold 122. The exhaust gases from the turbine section 130 of the second stage turbocharger 116 is provided to the turbine sections 128 of the first stage turbochargers 112, 114 of the air supply unit 110. Furthermore, a waste gate valve 136 is provided in the air supply unit 110 to control the flow of the exhaust gases through the turbine sections 130, 128, and thus control a flow of the exhaust gases into the turbocharger 116, 112, and 114. Accordingly, the waste gate valve 136 is configured to control air pressure within the air inlet manifold 118.

Further, the compressed air from the compressor section 124 of the first stage turbochargers 112, 114 is cooled at a first stage heat exchanger 138 (as shown by arrows 137). In one embodiment, the first stage heat exchanger 138 may be a single stage or multistage intercooler for cooling the air from the first stage turbochargers 112, 114. The first stage heat exchanger 138 may include a core of substantially rectangular shape that further includes fittings for circulation of a coolant, such as refrigerant, or water or the like.

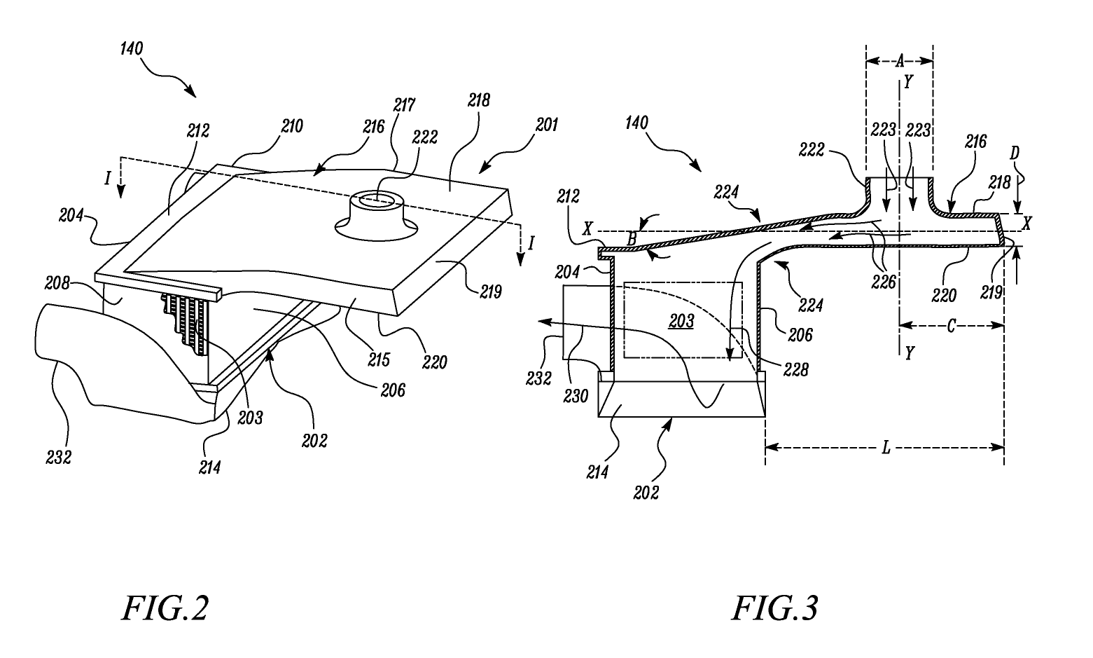

Further, the air from the first stage heat exchanger 138 is provided for compression at the compressor section 132 of the second stage turbocharger 116, as shown by arrow 141. The compressed air from the compressor section 132 of the second stage turbocharger 116 is passed to a second stage heat exchanger 140, as shown by arrow 142. For example, the second stage heat exchanger 140 is an after cooler. The second stage heat exchanger 140 is further described in greater detail with reference to FIGS. 2 and 3 in the following description. Furthermore, the air from the second stage heat exchanger 140 may be provided to the inlet manifold 118 of the engine 102, as shown by arrows 143. Although, there are two parallel first stage turbochargers and one second stage turbocharger shown in the figure, it will be understood by a person having ordinary skill in the art, that the configuration and the number of turbochargers, i.e., the number of first stage turbochargers and second stage turbochargers are merely exemplary and hence non-limiting of this disclosure. For example, there may be a single first stage turbocharger or there may be only one turbocharger in the air supply unit 110 which may be a high pressure turbocharger. In another example, the two first stage turbochargers may be connected in series configuration.

FIG. 2 illustrates a perspective view of an exemplary second stage heat exchanger 140. FIG. 3 illustrates a sectional view of the second stage heat exchanger 140 taken along axis I-I. The second stage heat exchanger 140 is configured to cool air prior to introduction into the engine 102. Although the second stage heat exchanger 140 is embodied as an after cooler, however it will be understood that the second stage heat exchanger 140 may be an intercooler or any other arrangement configured to exchange heat and cool down a fluid passing through it. The second stage heat exchanger 140 includes a heat exchanger housing 201 (hereinafter referred to as the housing 201) for cooling air prior to introduction into the engine 102 and a heat exchanger core 203 enclosed within the housing 201.

Referring to FIGS. 2 and 3, the housing 201 includes a cooling chamber 202 having four sidewalls 204, 206, 208 and 210, a top wall 212 and a bottom wall 214. Further, the cooling chamber 202 includes the heat exchanger core 203 integral with and disposed within the housing 201. In an embodiment, the heat exchanger core 203 includes a fin and tube type arrangement. For example, the heat exchanger core 203 may include tubes disposed within and configured to facilitate a flow of the coolant entering the heat exchanger core 203 from one end of the tube and exiting the heat exchanger core 203 from a second end of the tube (not shown). Further, the tubes run through one or more fins within the heat exchanger core 203. The fins are configured to facilitate a heat transfer between the air and the heat exchanger core 203.

Further, the housing 201 includes an inlet chamber 216 fluidically connected to the cooling chamber 202. The inlet chamber 216 is configured to direct the air from the second stage turbocharger 116 into the cooling chamber 202 of the housing 201. In one embodiment, the inlet chamber 216 includes a top surface 218 that extends laterally from the top wall 212 of the cooling chamber 202. Further, the inlet chamber 216 includes a bottom surface 220 that extends laterally from the side wall 206 of the cooling chamber 202. In one embodiment, the bottom surface 220 is disposed at a pre-determined distance “D” from the top surface 218 and indicative of an inlet chamber depth. Furthermore, the inlet chamber 216 is configured to be closed at three ends by side surfaces 215, 217 and 219. In an embodiment, a length “L” of the inlet chamber 216 may be defined by a distance between the side wall 206 of the cooling chamber 202 and the side surface 219 of the inlet chamber 216

Furthermore, the inlet chamber 202 includes an inlet 222 disposed on the top surface 218. In an exemplary embodiment, the inlet 222 is a diverging circular shaped inlet. However, the shape of the inlet 222 is merely exemplary and hence non-limiting of this disclosure. In other embodiments, the shape of the inlet 222 may be a straight constant cross-section shape or a variety of revolved shapes. According to an aspect of the present disclosure, the inlet 222 may include an inlet diameter “A”. In an embodiment, a center line Y-Y passing through a center of the inlet 222 may be at a distance “C” from the side surface 219, indicative of a distance of the inlet 222 from the side surface 219 of the inlet chamber 216.

Furthermore, the inlet chamber 216 fluidically connects and transitions into the cooling chamber 202 via a diverging duct 224. For example, the diverging duct 224 is disposed at a pre-determined angle “B” with respect to an axis X-X passing through a center of the inlet chamber 216.

In an aspect of the present disclosure, a first ratio of the distance “C” of the inlet 222 to the length “L” of the inlet chamber 216 is within a range of 0.25 to 0.65. In a further aspect of the present disclosure, a second ratio of the diameter “A” of the inlet 222 to the length “L” of the inlet chamber 216 is within a range of 0.1 to 0.4. In a still further aspect of the present disclosure, a third ratio of the inlet diameter “A” to the predetermined distance “D” of the bottom surface 220 from the top surface 218 is within a range of 1.0 to 3.0.

In an aspect of the present disclosure, the inlet 222 of the inlet chamber 216 is configured to direct the air from the second stage turbocharger 118 in a first direction, such as a vertically downward direction (as shown by the arrows 223). Further, the bottom surface 220 of the inlet chamber 216 is perpendicular to the incoming flow of the air through the inlet 222 in a first direction 223 and configured to turn the air in a second direction 226 that is substantially perpendicular to the first direction 223.

As will be understood by a person having ordinary skill in the art, that by virtue of the design of the inlet chamber 216 (being closed from one end by the side surface 219) and the diverging duct 224, the air from the second stage turbocharger 116 is turned to a third direction substantially perpendicular to the second direction as shown by arrows 228. In an embodiment, the diverging duct 224 may be configured to reduce the velocity of the air flowing in the third direction.

In an aspect of the present disclosure, the bottom wall 214 of the cooling chamber 202 may be a chevron shaped wall. The chevron shaped bottom wall 214 is configured to diverge the air within the cooling chamber 202 from a center towards one or more exits 232 (as shown by arrow 230). In an alternate embodiment, the bottom wall 214 may be a curved wall configured to provide a divergence of the air towards the exits 232. It will be understood that the shape of the bottom wall 214 is merely exemplary and may be varied to achieve similar results. The exits 232 connect the heat exchanger housing 201 to the air intake manifold 118 of the engine 102. In one embodiment, the housing 201 of the heat exchanger 140 is constructed of a high strength and low weight metal alloy, such as steel and high strength low alloy steel (HSLA).

Although the description is in conjunction to a heat exchanger for cooling compressed air prior to introduction to the engine, it will be understood that the heat exchanger may be an intermediate heat exchanger to cool any compressed fluid prior to introduction to a second stage compressor.

### INDUSTRIAL APPLICABILITY

Use of turbocharged engines is generally known. As a turbocharger increases the quantity of the air taken for combustion in the engine, it also increases the temperature of the intake air. Therefore, for cooling the intake air, a heat exchanger may be used between the turbocharger and intake manifolds of the engine. The heat exchanger includes coolant that flows through a heat exchanger core of the heat exchanger and further cools down the high temperature air from the turbocharger. However, maintaining a high pressure with low temperature is an essential feature of the heat exchanger. Generally, these heat exchangers include an inlet for the air to enter into a cooling chamber that houses the heat exchanger core. Typically, the air hits a bottom of the cooling chamber directly from the inlet, resulting in loss of pressure and generation of turbulence within the cooling chamber.

According to the present disclosure, the heat exchanger 140 including the housing 201, the inlet chamber 216 and the cooling chamber 202 is provided. The inlet chamber 216 facilitates an even and uniform distribution of the air from the turbocharger 116 to the cooling chamber 202. The inlet chamber 216 includes the top surface 218 and the bottom surface 220 disposed at the pre-determined distance “D” from the top surface 218 indicative of the depth of the inlet chamber 216, to provide an optimal distance to be covered by the incoming air from the turbocharger 116 thereby facilitating a quick uniform distribution of the air within the inlet chamber 216. In a further aspect of the present disclosure, the first ratio of the distance “C” of the inlet 222 from the side surface 219 of the inlet chamber 216 to the length “L” of the inlet chamber 216 is maintained within a range of 0.25 to 0.65, as the location of the inlet 222 may be offset from the cooling chamber 202 and the side wall 219. Furthermore, the second ratio of the inlet diameter “A” to the length “L” of the inlet chamber 216 is maintained within a range of 0.1 to 0.4, as the length of the inlet chamber 216 needs to be substantially larger than the inlet diameter “A” of the inlet 222. The third ratio of the inlet diameter “A” to the inlet chamber depth “D” is within a range of 1.0 to 3.0. As will be understood by a person having ordinary skill in the art, the first ratio, the second ratio and the third ratio in combination with each other may be configured to facilitate a quick uniform distribution of the air within the inlet chamber 216 prior to entering into the cooling chamber 202 of the heat exchanger 140.

In an aspect of the present disclosure, the diverging duct 224 provides smooth reduction of speed of travel of the air from the inlet chamber 216 to the cooling chamber 202 with minimum pressure loss. In a further embodiment, the chevron shaped bottom wall 214 of the cooling chamber 202 facilitates the cool air to be uniformly diverged from the center of the cooling chamber 202 towards the exits 232 to further enter the air intake manifold 118 of the engine 102. The shape of the bottom wall 214 also provides a turning velocity to the outgoing air from the center of the cooling chamber 202.

While aspects of the present disclosure have been particularly shown and described with reference to the embodiments above, it will be understood by those skilled in the art that various additional embodiments may be contemplated by the modification of the disclosed engine systems and methods without departing from the spirit and scope of what is disclosed. Such embodiments should be understood to fall within the scope of the present disclosure as determined based upon the claims and any equivalents thereof.

What is claimed is:

1. A housing for cooling air prior to introduction into an engine, the housing comprising:
a cooling chamber having four side walls, a top wall and a bottom wall; and
an inlet chamber fluidically connected to the cooling chamber, the inlet chamber comprising:
a top surface laterally extending from the top wall of the cooling chamber;
an inlet disposed on the top surface and configured to direct air in a first direction; and
a bottom surface laterally extending from at least one side wall of the cooling chamber, the bottom surface is disposed substantially perpendicular to the first direction at a predetermined distance from the top surface of the inlet chamber and configured to turn air in a second direction substantially perpendicular to the first direction prior to entering into the cooling chamber.

2. The housing of claim 1 further includes a diverging duct disposed at a pre-determined angle from an axis passing through a center of the inlet chamber and configured to fluidically connect the inlet chamber to the cooling chamber.

3. The housing of claim 1, wherein the inlet includes an inlet diameter such that a ratio of the inlet diameter to the predetermined distance lies substantially within a range of about 1.0 to 3.0.

4. The housing of claim 1, wherein a ratio of an inlet diameter to a length of the inlet chamber lies substantially within a range of about 0.1 to 0.4.

5. The housing of claim 1, wherein a ratio of a distance of the inlet from a side surface of the inlet chamber to the inlet diameter lies substantially within a range of about 0.25 and 0.65.

6. The housing of claim 1, wherein the bottom wall of the cooling chamber is substantially of a chevron shape and configured to diverge the air within the cooling chamber towards one or more exits of the cooling chamber.

7. A heat exchanger housing comprising:
a cooling chamber having four side walls, a top wall and a bottom wall; and
an inlet chamber fluidically connected to the cooling chamber, the inlet chamber comprising:
a top surface laterally extending from the top wall of the cooling chamber;
an inlet disposed on the top surface and configured to direct a fluid in a first direction; and
a bottom surface laterally extending from at least one side wall of the cooling chamber, the bottom surface is disposed substantially perpendicular to the first direction at a predetermined distance from the top surface of the inlet chamber and configured to turn the fluid in a second direction substantially perpendicular to the first direction prior to entering into the cooling chamber.

8. The heat exchanger housing of claim 7, wherein the heat exchanger is one of an after cooler and an intercooler.

9. The heat exchanger housing of claim 7 further includes a diverging duct disposed at a predetermined angle from an axis passing through a center of the inlet chamber and configured to fluidically connect the inlet chamber to the cooling chamber.

10. The heat exchanger housing of claim 7, wherein the inlet includes an inlet diameter such that a ratio of the inlet diameter to the predetermined distance lies substantially within a range of about 1.0 to 3.0.

11. The heat exchanger housing of claim 7, wherein a ratio of an inlet diameter to a length of the inlet chamber lies substantially within a range of about 0.1 to 0.4.

12. The heat exchanger housing of claim 7, wherein a ratio of a distance of the inlet from a side surface of the inlet chamber to the inlet diameter lies substantially within a range of about 0.25 and 0.65.

13. The heat exchanger housing of claim 7, wherein the bottom wall of the cooling chamber is substantially of a chevron shape and configured to diverge the air within the cooling chamber towards one or more exits of the cooling chamber.

14. A heat exchanger comprising:
a heat exchanger core; and
a heat exchanger housing including:
a cooling chamber having four side walls, a top wall and a bottom wall; and
an inlet chamber fluidically connected to the cooling chamber, the inlet chamber comprising:
a top surface laterally extending from the top wall of the cooling chamber;
an inlet disposed on the top surface and configured to direct a fluid in a first direction; and
a bottom surface laterally extending from at least one side wall of the cooling chamber, the bottom surface is disposed substantially perpendicular to the first direction at a predetermined distance from the top surface of the inlet chamber and configured to turn the fluid in a second direction substantially perpendicular to the first direction prior to entering into the cooling chamber.

15. The heat exchanger of claim 13, wherein the heat exchanger is one of an after cooler and an intercooler.

16. The heat exchanger of claim 13 further includes a diverging duct disposed at a pre-determined angle from an axis passing through a center of the inlet chamber and configured to fluidically connect the inlet chamber to the cooling chamber.

17. The heat exchanger of claim 13, wherein the inlet includes an inlet diameter such that a ratio of the inlet diameter to the pre-determined distance lies substantially within a range of about 1.0 to 3.0.

18. The heat exchanger of claim 13, wherein a ratio of an inlet diameter to a length of the inlet chamber lies substantially within a range of about 0.1 to 0.4.

19. The heat exchanger of claim 13, wherein a ratio of a distance of the inlet from a side surface of the inlet chamber to the inlet diameter lies substantially within a range of about 0.25 and 0.65.

20. The heat exchanger of claim 13, wherein the bottom wall of the cooling chamber is substantially of a chevron shape and configured to diverge the air within the cooling chamber towards one or more exits of the cooling chamber.
